(19) United States
(12) Patent Application Publication
(10) Pub. No.: US 2009/0168008 A1
(43) Pub. Date: Jul. 2, 2009

(54) Liquid Crystal Composition and Liquid Crystal Display Device Having the Same

(76) Inventors: Su-Jung Huh, Yongin-si (KR); Duck-jong Suh, Seoul (KR); So-youn Park, Suwon-si (KR)

Correspondence Address: Frank Chau, Esq.;F. CHAU & ASSOCIATES, LLC, 130 Woodbury Road, Woodbury Road, NY, 11797, US

(21) Appl. No.: 12/338,753

(22) Filed: Dec. 18, 2008

(30) Foreign Application Priority Data
Dec. 26, 2007 (KR) 10-2007-0137911

(51) Int. Cl. G02F 1/13; C09K 19/34

(52) U.S. Cl. 349/167; 252/299.61; 349/182

(57) ABSTRACT

A liquid crystal composition has low refractive anisotropy to be favorable to low cell gap, has high dielectric anisotropy to be favorable to low voltage driving and has low rotational viscosity to be favorable to fast response time.

### CROSS-REFERENCE TO RELATED APPLICATIONS

This application claims priority from Korean Patent Application No. 10-2007-0137911, filed on Dec. 26, 2007, the disclosure of which is hereby incorporated by reference herein in its entirety.

### BACKGROUND OF INVENTION

1. Technical Field

The present disclosure relates to a liquid crystal composition and to a liquid crystal display device having the same, more particularly to a twisted nematic (TN) liquid crystal composition and a liquid crystal display device having the same.

2. Description of Related Art

A liquid crystal display (LCD) device includes a first substrate, a second substrate, and a liquid crystal layer disposed between the substrates. The two substrates form an electric field. The liquid crystal layer may be formed of a liquid crystal composition and selective additives.

The LCD device is being used for a large-sized display device such as a television. It is also noted that the LCD device has improved considerably with regard to viewing angle, color reproducibility, and brightness. However, the response time of the LCD device is still needs further improvement.

The LCD device is also being employed for portable electronic equipment such as, for example, a notebook, which can be driven at a low voltage level.

The response time of the LCD device is closely related to the rotational viscosity of a liquid crystal composition.

That is, when the liquid crystal composition has a low rotational viscosity, the LCD device may have a shorter response time. Meanwhile, a driving voltage required for the LCD device is closely connected with the dielectric anisotropy of the liquid crystal composition. Namely, when the liquid crystal composition has a high dielectric anisotropy, the LCD device can be driven at a low voltage level.

Thus, a liquid crystal composition with a low rotational viscosity and high dielectric anisotropy is favorable to improve the response time of the LCD device and to drive the device at a low voltage level.

However, liquid crystal molecules forming a liquid crystal composition generally have high rotational viscosity when they have high dielectric anisotropy. Thus, it may be difficult to improve the response time of the LCD device and drive the device at low voltage at the same time.

Further, a distance between two substrates, e.g., cell gap, should to be short to improve response time. A liquid crystal composition having a high refractive anisotropy is favorable to obtain a desired delay value of a liquid crystal layer with a short cell gap.

### SUMMARY OF INVENTION

Exemplary embodiments of the present invention may provide a liquid crystal composition having both high refractive anisotropy and dielectric anisotropy, and low rotational viscosity.

Exemplary embodiments of the present invention may provide an LCD device having an improved response time, capable of being driven at low voltage, and having a short cell gap.

In accordance with an exemplary embodiment of the present invention a liquid crystal composition is provided.

The liquid crystal composition includes about 35 to about 50% of Compound 1 represented by Chemical formula 1, about 5 to about 15% of Compound 2 including at least one of Compound 2-1 represented by Chemical formula 2-1, Compound 2-2 represented by Chemical formula 2-2, Compound 2-3 represented by Chemical formula 2-3, Compound 2-4 represented by Chemical formula 2-4, and Compound 2-5 represented by Chemical formula 2-5, about 5 to about 15% of Compound 3 including at least one of Compound 3-1 represented by Chemical formula 3-1 and Compound 3-2 represented by Chemical formula 3-2, about 5 to about 10% of Compound 4 represented by Chemical formula 4, and about 10 to about 30% of Compound 5 including at least Compound 5-1 represented by Chemical formula 5-1, Compound 5-2 represented by Chemical formula 5-2, and Compound 5-3 represented by Chemical formula 5-3:

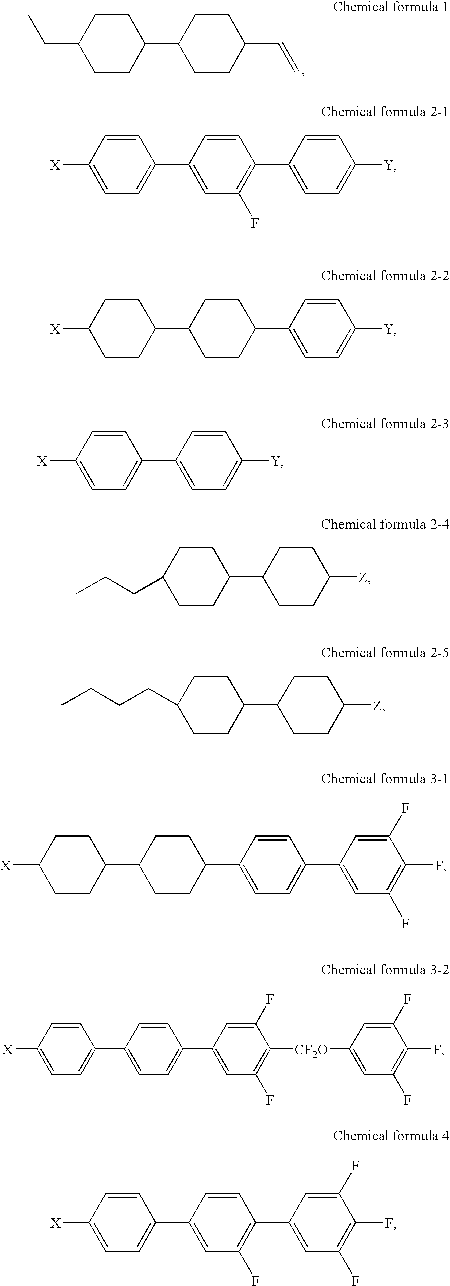

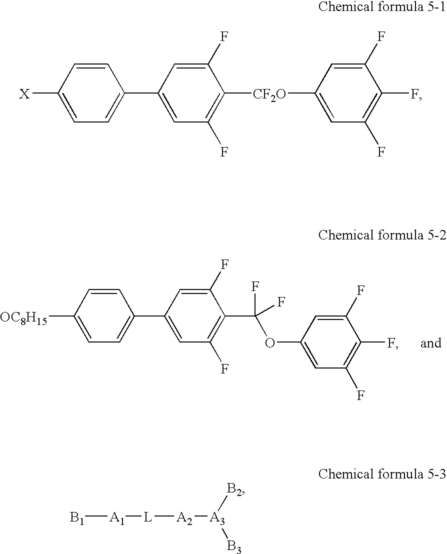

in the formulas, X independently represents a C2 to C7 alkyl or alkoxy group, Y independently represents a C2 to C7 alkyl or alkenyl group, Z represents a C2 to C7 alkenyl group, A₁, A₂, and A₃ each independently represent one of

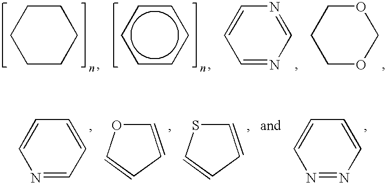

n independently represents one of 1 to 10, B₁ represents one of a C1 to C10 alkyl, alkoxy, alkenyl, and alkenyloxy group, B₂ represents one of F, Cl, and CN, B₃ represents one of a C1 to C10 alkyl group, a C1 to C10 alkoxy group, CN, and halogen, and L represents a tolane group, an ester group, a C1 to C10 alkoxy group, and a C1 to C10 alkyl group or does not exist.

The compound 5 may comprise the compound 5-2 and compound 5-3.

A dielectric anisotropy of the liquid crystal composition may be about 6.0 to about 9.0 at 20° C.

A refractive anisotropy of the liquid crystal composition may be about 0.12 to about 0.14 at 20° C.

A rotational viscosity of the liquid crystal composition may be about 55 mPa·s to about 65 mPa·s at 20° C.

A pitch of the liquid crystal composition may be about 45 μm to about 55 μm.

In accordance with an exemplary embodiment of the present invention, a liquid crystal display device is provided. The liquid crystal display includes a first substrate including a thin film transistor and a pixel electrode electrically connected to the thin film transistor, a second substrate facing the first substrate and including a common electrode; and a liquid crystal layer disposed between the first substrate and the second substrate. The liquid crystal layer includes a liquid crystal composition which includes about 35 to about 50% of Compound 1 represented by Chemical formula 1, about 5 to about 15% of Compound 2 including at least one of Compound 2-1 represented by Chemical formula 2-1, Compound 2-2 represented by Chemical formula 2-2, Compound 2-3 represented by Chemical formula 2-3, Compound 2-4 represented by Chemical formula 2-4, and Compound 2-5 represented by Chemical formula 2-5, about 5 to about 15% of Compound 3 including at least one of Compound 3-1 represented by Chemical formula 3-1 and Compound 3-2 represented by Chemical formula 3-2, about 5 to about 10% of Compound 4 represented by Chemical formula 4, and about 10 to about 30% of Compound 5 including at least Compound 5-1 represented by Chemical formula 5-1, Compound 5-2 represented by Chemical formula 5-2, and Compound 5-3 represented by Chemical formula 5-3:

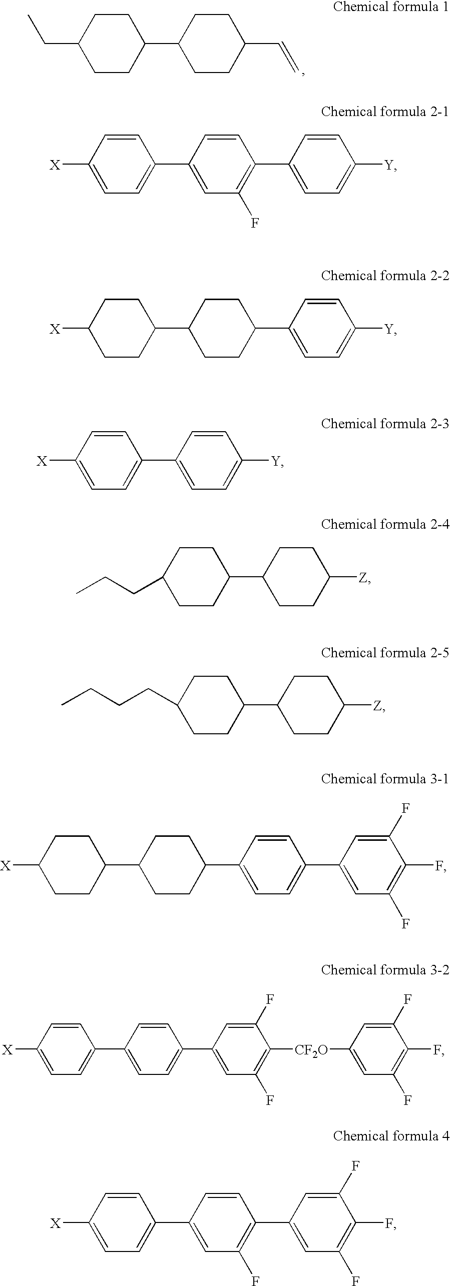

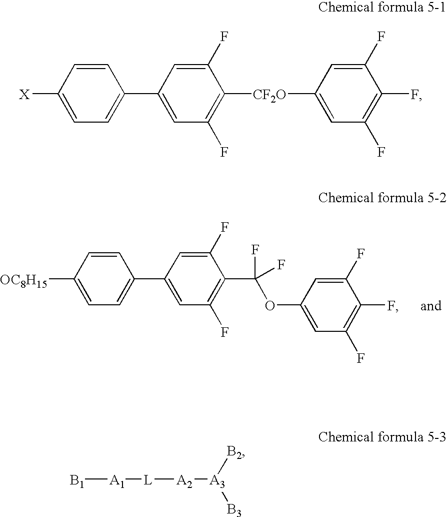

in the formulas, x independently representing a C2 to C7 alkyl or alkoxy group, Y independently representing a C2 to C7 alkyl or alkenyl group, Z representing a C2 to C7 alkenyl group, A₁, A₂, and A₃ each independently representing one of

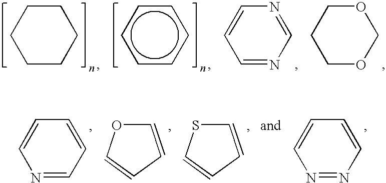

n independently representing one of 1 to 10, B₁ representing one of a C1 to C10 alkyl, alkoxy, alkenyl, and alkenyloxy group, B₂ representing one of F, Cl, and CN, B₃ representing one of a C1 to C10 alkyl group, a C1 to C10 alkoxy group, CN, and halogen, and L representing a tolane group, an ester group, a C1 to C10 alkoxy group, and a C1 to C10 alkyl group or does not exist.

The compound 5 may comprise the compound 5-2 and compound 5-3.

A dielectric anisotropy of the liquid crystal composition may be about 6.0 to about 9.0 at 20° C.

A refractive anisotropy of the liquid crystal composition may be about 0.12 to about 0.14 at 20° C.

A rotational viscosity of the liquid crystal composition may be about 55 mPa·s to about 65 mPa·s at 20° C.

A pitch of the liquid crystal composition may be about 45 μm to about 55 μm.

A cell gap of the liquid crystal display device may be about 2.5 μm to about 3.5 μm

A driving voltage (AVDD) of the liquid crystal display device may be about 8.0V to about 9.0V.

A response time of the liquid crystal layer may be about 4.5 ms to about 6 ms.

A contrast ratio of the liquid crystal display device may be about 700:1 to about 1200:1.

A delay value of the liquid crystal layer may be about 380 nm to about 440 nm.

### BRIEF DESCRIPTION OF DRAWINGS

Exemplary embodiments of the present invention can be understood in more detail from the following description, taken in conjunction with the accompanying drawings, in which:

FIG. 1 is an arrangement view of a first substrate in an LCD device according to an exemplary embodiment of the present invention; and

FIG. 2 is a cross-sectional view taken along line II-II in FIG. 1.

### DETAILED DESCRIPTION OF EXEMPLARY EMBODIMENTS OF INVENTION

Reference will now be made in detail to the embodiments of the present invention, examples of which are illustrated in the accompanying drawings, wherein like reference numerals refer to like elements throughout.

In the following description, if a layer is said to be formed ‘on’ another layer, a third layer may be disposed between the two layers or the two layers may be in contact with each other. In other words, it will be understood that when an element such as a layer, film, region, or substrate is referred to as being “on” another element, it can be directly on the other element or intervening elements may also be present.

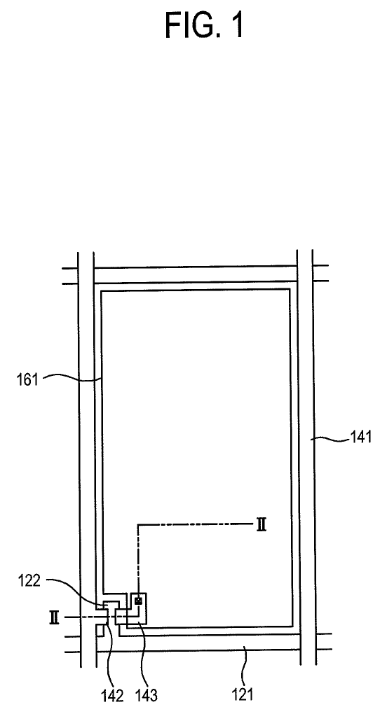

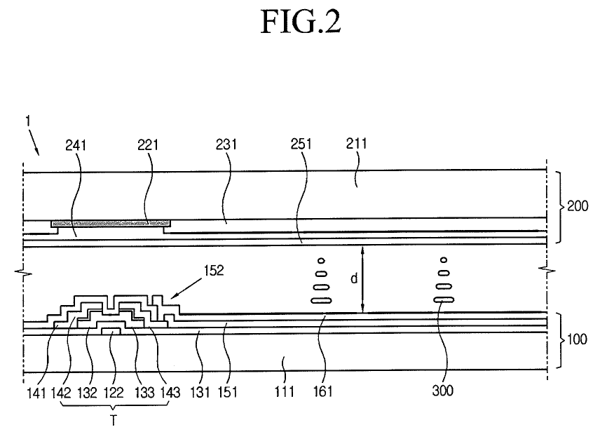

An LCD device according to an exemplary embodiment of the present invention will be described with reference to FIGS. 1 and 2.

The LCD device 1 includes a first substrate 100 where thin film transistors (T) are formed, a second substrate 200 (not shown in FIG. 1) facing the first substrate 100, and a liquid crystal layer 300 (not shown in FIG. 1) disposed between the substrates 100 and 200.

First of all, the first substrate 100 will be described as below.

A gate wiring 121 and 122 is formed on a first insulating substrate 111. The gate wiring 121 and 122 may be, for example, a metal single layer or a metal multilayer.

The gate wiring 121 and 122 includes a gate line 121 disposed within a display region and extending transversely and a gate electrode 122 connected to the gate line 121.

A gate insulating layer 131 made of, for example, silicon nitride (SiNx) or the like is formed on the first insulating substrate 111 to cover the gate wiring 121 and 122.

A semiconductor layer 132 made of, for example, amorphous silicon is formed on the gate insulating layer 131 over the gate electrode 122. An ohmic contact layer 133 made of, for example, hydrogenated amorphous silicon highly doped with n-type impurities is formed on the semiconductor layer 132. The ohmic contact layer 133 is excluded in a channel area between a source electrode 142 and a drain electrode 143.

A data wiring 141, 142, and 143 is formed on the ohmic contact layer 133 and the gate insulating layer 131. The data wiring 141, 142, and 143 may be, for example, a metal single layer or a metal multilayer.

The data wiring 141, 142, and 143 includes a data line 141 formed lengthwise to intersect the gate line 121 to form a pixel, the source electrode 142 branched from the data line 141 and extended over the ohmic contact layer 133, and the drain electrode 143 separated from the source electrode 142 and formed on a portion of the ohmic contact layer 133 opposite to the source electrode 142.

A passivation layer 151 is formed on the data wiring 141, 142, and 143 and a portion of the semiconductor layer 132 not covered with the data wiring. The passivation layer 151 is formed with a contact hole 152 to expose the drain electrode 143.

A pixel electrode 161 is formed on the passivation layer 151. The pixel electrode 161 is generally made of, for example, a transparent conductive material such as indium tin oxide (ITO) or indium zinc oxide (IZO).

The configuration of the first substrate 100 according to exemplary embodiments of the present invention is not limited to the aforementioned. The first substrate 100 may have various modifications, e.g., a semiconductor layer 132 of poly silicon or a top-gate TFT.

Next, the second substrate 200 will be described.

A black matrix 221 is formed on a second insulating substrate 211. The black matrix 221 is disposed between red, green and blue filters to divide the filters and prevents light from being irradiated directly to the TFTs on the first substrate 100. The black matrix 221 is typically made of, for example, a photoresist organic material including a black pigment. The black pigment may be, for example, carbon black or the like.

A color filter layer 231 includes red, green and blue filters which are alternately disposed and separated by the black matrix 221. The color filter layer 231 endows colors to light irradiated from a backlight unit and passing through the liquid crystal layer 300. The color filter layer 231 is generally made of, for example, a photoresist organic material.

An overcoat layer 241 is formed on the color filter layer 231 and a portion of the black matrix 221 not covered with the color filter layer 231. The overcoat layer 241 provides a planar surface and protects the color filter layer 231. The overcoat layer 241 may be formed of, for example, photoresist acrylic resin.

A common electrode 251 is formed on the overcoat layer 241. The common electrode 251 is made of a transparent conductive material such as, for example, ITO or IZO. The common electrode 251 applies voltage to the liquid crystal layer 300 along with the first electrode 161 of the first substrate 100.

The liquid crystal layer 300 is disposed between the first substrate 100 and the second substrate 200. The liquid crystal layer 300 is twisted nematic mode, in which liquid crystal molecules in the liquid crystal layer 300 being twisted at about 90 degrees by alignment films formed on the first substrate 100 and the second substrate 200. The liquid crystal molecules are arranged with their major axes vertical to the substrates 100 and 200 when a vertical electric field is formed between the first substrate 100 and the second substrate 200.

In the present exemplary embodiment, the LCD device 1 is in the normally white mode, which displays white by passing through light in a voltage-off state and displays black by blocking light when a vertical electric field is formed between the first substrate 100 and the second substrate 200.

The liquid crystal layer 300 of exemplary embodiments of the present invention includes a liquid crystal composition explained below, further including known additives if necessary. The additives may include, for example, dyes, a UV stabilizer, and/or an antioxidant. Also, the liquid crystal composition may further include, for example, a chiral dopant to control the pitch of liquid crystal molecules. In the following, it is considered that the liquid crystal composition and the liquid crystal layer 300 have the same properties.

The liquid crystal composition includes the following elements. The term of “percent (%)”, mentioned below indicates weight percent.

Compound 1 represented by Chemical formula 1: about 35 to about 50%

Compound 2 including at least one of Compound 2-1 represented by Chemical formula 2-1, Compound 2-2 represented by Chemical formula 2-2, Compound 2-3 represented by Chemical formula 2-3, Compound 2-4 represented by Chemical formula 2-4, and Compound 2-5 represented by Chemical formula 2-5: about 5 to about 15% Compound 3 including at least one of Compound 3-1 represented by Chemical formula 3-1 and Compound 3-2 represented by Chemical formula 3-2: about 5 to about 15% Compound 4 represented by Chemical formula 4: about 5 to about 10%

Compound 5 including at least Compound 5-1 represented by Chemical formula 5-1, Compound 5-2 represented by Chemical formula 5-2, and Compound 5-3 represented by Chemical formula 5-3: about 10 to about 30%

Compounds 1 and 2 are a non-polar substance, and Compounds 3 to 5 are a polar substance.

Here, Compound 1 has a very low rotational viscosity to be favorable for quick response, but a low refractive anisotropy and dielectric anisotropy. Compound 3 has a very high refractive anisotropy, and Compounds 4 and 5 have a very high dielectric anisotropy.

Thus, the use of Compound 3 enables the refractive anisotropy of the liquid crystal composition to be kept high although the amount of Compound 1 is increased. Also, the use of Compounds 4 and 5 enables the dielectric anisotropy of the liquid crystal composition to be kept high although the amount of Compound 1 is increased. Further, because of the increase of Compound 1 in amount, the liquid crystal composition may have a low rotational viscosity.

That is, the liquid crystal composition may have a low rotational viscosity due to Compound 1, a high refractive anisotropy due to Compound 3, and a high dielectric anisotropy due to Compounds 4 and 5. Accordingly, the LCD device 1 can have a short response time and cell gap and be driven at low voltage.

Meanwhile, as Compounds 5-2 and 5-3 are high particularly in dielectric anisotropy, the liquid crystal composition desirably includes Compounds 5-2 and 5-3. In particular, as Compound 5-3 has a phase transition temperature (Tni) of about 100° C. or more so that the liquid crystal composition favorably has a high phase transition temperature.

The content of Compound 5-1 with a relatively high rotational viscosity may be about 15% or less, and the content of Compound 4 with a relatively high rotational viscosity may be about 10% or less.

The aforementioned liquid crystal composition has a dielectric anisotropy of about 6.0 to about 9.0 at 20° C., a refractive anisotropy of about 0.12 to about 0.14 at 20° C., and a rotational viscosity of about 55 mPa·s to about 65 mPa·s at 20° C.

Because of the liquid crystal composition with a comparatively high dielectric anisotropy of about 6.0 to about 9.0, the LCD device 1 can be smoothly driven under a low driving voltage (AVDD) of about 9.0V or less. Here, a black voltage (Vb) may be about 3.8V to about 4.2V, specifically about 4.0V, and a white voltage (Vw) may be about 0.2V to about 0.4V, specifically about 0.3V. A driving voltage may be about 8.0V to about 9.0V, specifically about 8.0V to about 8.5V. The liquid crystal composition may have a dielectric anisotropy of about 7.0 to about 8.0 at 20° C., more in detail.

As the liquid crystal composition has a comparatively high refractive anisotropy of about 0.12 to about 0.14 at 20° C., the cell gap (d) is kept comparatively low, about 2.5 μm to about 3.5 μm. The liquid crystal layer 300 may have a delay value of about 380 nm to about 440 nm. More specifically, the liquid crystal composition may have a refractive anisotropy of about 0.125 to about 0.135 at 20° C., and the cell gap may be about 3.0 μm to about 3.25 μm.

Because of the liquid crystal composition with a comparatively low rotational viscosity of about 55 mPa·s to about 65 mPa·s at 20° C., the liquid crystal layer 300 has a decreased response time. More specifically, the liquid crystal composition has a rotational viscosity of about 55 mPa·s to about 63 mPa·s at 20° C.

Meanwhile, the liquid crystal composition may include chiral dopant. As chiral dopant is more added, the liquid crystal molecules have a decreasing pitch so that an elastic coefficient becomes high and restoring force increases. When restoring force increases, response time may decrease. The liquid crystal molecules of the liquid crystal composition may have a pitch of about 45 μm to about 55 μm by chiral dopant.

Meanwhile, the liquid crystal composition has a comparatively high phase transition temperature of about 70° C. to about 80° C., more specifically about 74° C. to about 76° C.

Under the foregoing cell gap and driving voltage, the liquid crystal composition has a comparatively short response time of about 4.5 ms to about 6.0 ms.

Liquid crystal compositions with different compositions are measured regarding properties and response times through experiments.

Six kinds of liquid crystal compositions according to Examples 1 to 6 are used in the experiments, and experimental results are given in Table 1.

TABLE 1

| | Example 1 | Example 2 | Example 3 | Example 4 | Example 5 | Example 6 |
|---|---|---|---|---|---|---|
| Phase | 75.0 | 75.0 | 74.9 | 75.0 | 75.0 | 74.4 |
| transition | | | | | | |
| temperature | | | | | | |
| (Tni, ° C.) | | | | | | |
| γ1 | 58.6 | 60.7 | 62.8 | 57.0 | 59.0 | 61.3 |
| (mPa · s) | | | | | | |
| Δn | 0.135 | 0.136 | 0.135 | 0.124 | 0.125 | 0.125 |
| Δε | 6.7 | 7.4 | 8.0 | 6.5 | 7.2 | 7.8 |
| Pitch (μm) | 50 | 50 | 50 | 50 | 50 | 50 |
| Response | 4.72 | 4.78 | 4.90 | 5.5 | 5.7 | 5.75 |
| time (ms) | | | | | | |
| Contrast ratio | 800 | 1000 | 1100 | 750 | 1000 | 1050 |

Response times in Examples 1 to 3 are obtained under a cell gap of about 3.0 μm and a driving voltage of about 8.5V, and response times in Examples 4 to 6 are obtained under a cell gap of about 3.25 μm and a driving voltage of about 8.5V.

The response time of a liquid crystal composition is determined by the sum of a rising time (Ton) and a falling time (Toff). When the response time of liquid crystals is long, motion blur occurs to deteriorate the quality of a display.

The experimental results in Table 1 confirms a short response time of about 4.5 ms to about 6.0 ms. Further, it is confirmed to obtain a contrast ratio of about 750 or more. The contrast ratio may be about 700:1 to about 1200:1.

Although not mentioned in Table 1, it has been confirmed that the liquid crystal composition according to exemplary embodiments of the present invention may not be substantially increased in rotational viscosity although the cell gap may be decreased. Further, when the pitch of the liquid crystal molecules is adjusted to about 50 μm as in exemplary embodiments of the present invention, the response time may be decreased by about 5% to about 10% as compared with the pitch of about 70 μm.

The experimental results confirm that the LCD device according to exemplary embodiments of the present invention may provide a response time of about 6 ms or less, a driving voltage of about 9V or less, and a short cell gap.

The liquid crystal layer 300 may be formed by a dropping method.

As described above, exemplary embodiments of the present invention may provide a liquid crystal composition having both high refractive anisotropy and dielectric anisotropy, and low rotational viscosity.

Also, exemplary embodiments of the present invention may provide a LCD device having an improved response time, capable of being driven at low voltage, and having a short cell gap.

Having described the exemplary embodiments of the present invention, it is further noted that it is readily apparent to those of reasonable skill in the art that various modifications may be made without departing from the spirit and scope of the present invention which defined by the metes and bound of the appended claims.

What is claimed is:

1. A liquid crystal composition comprising
about 35 to about 50% of Compound 1 represented by Chemical formula 1,
about 5 to about 15% of Compound 2 including at least one of Compound 2-1 represented by Chemical formula 2-1, Compound 2-2 in Chemical formula 2-2, Compound 2-3 represented by Chemical formula 2-3, Compound 2-4 represented by Chemical formula 2-4, and Compound 2-5 represented by Chemical formula 2-5,
about 5 to about 15% of Compound 3 including at least one of Compound 3-1 represented by Chemical formula 3-1 and Compound 3-2 represented by Chemical formula 3-2,
about 5 to about 10% of Compound 4 represented by Chemical formula 4, and
about 10 to about 30% of Compound 5 including at least one of Compound 5-1 represented by Chemical formula 5-1, Compound 5-2 represented by Chemical formula 5-2, and Compound 5-3 represented by Chemical formula 5-3: 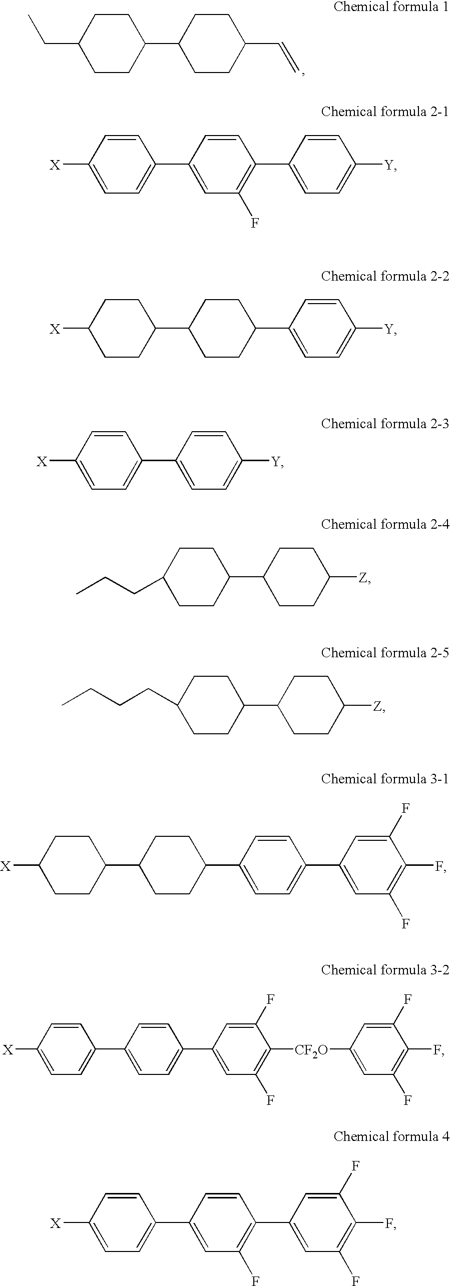 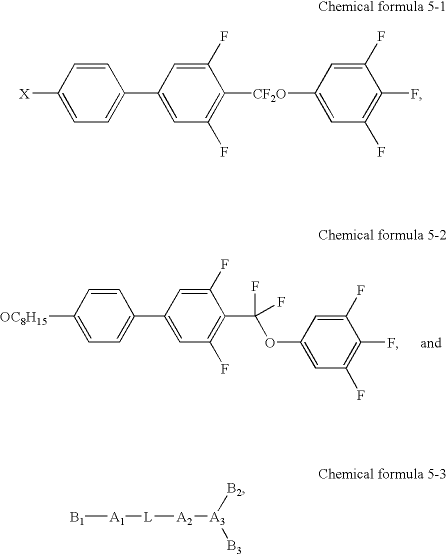
in the formulas, X independently represents a C2 to C7 alkyl or alkoxy group, Y independently represents a C2 to C7 alkyl or alkenyl group, Z represents a C2 to C7 alkenyl group, A₁, A₂, and A₃ each independently represent one of 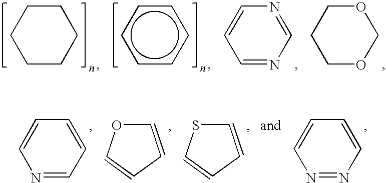
n independently represents one of 1 to 10, B₁ represents one of a C1 to C10 alkyl, alkoxy, alkenyl, and alkenyloxy group, B₂ represents one of F, Cl, and CN, B₃ represents one of a C1 to C10 alkyl group, a C1 to C10 alkoxy group, CN, and halogen, and L represents a tolane group, an ester group, a C1 to C10 alkoxy group, and a C1 to C10 alkyl group or does not exist.

2. The liquid crystal composition according to claim 1, wherein the compound 5 comprises the compound 5-2 and compound 5-3.

3. The liquid crystal composition according to claim 1, wherein a dielectric anisotropy of the liquid crystal composition is about 6.0 to about 9.0 at 20° C.

4. The liquid crystal composition according to claim 1, wherein a refractive anisotropy of the liquid crystal composition is about 0.12 to about 0.14 at 20° C.

5. The liquid crystal composition according to claim 1, wherein a rotational viscosity of the liquid crystal composition is about 55 mPa·s to about 65 mPa·s at 20° C.

6. The liquid crystal composition according to claim 1, wherein a pitch of the liquid crystal composition is about 45 μm to about 55 μm.

7. A liquid crystal display device comprising:
a first substrate including a thin film transistor and a pixel electrode electrically connected to the thin film transistor;
a second substrate facing the first substrate and including a common electrode; and
a liquid crystal layer disposed between the first substrate and the second substrate,
the liquid crystal layer comprising a liquid crystal composition including
about 35 to about 50% of Compound 1 represented by Chemical formula 1,
about 5 to about 15% of Compound 2 including at least one of Compound 2-1 represented by Chemical formula 2-1, Compound 2-2 represented by Chemical formula 2-2, Compound 2-3 represented by Chemical formula 2-3, Compound 2-4 represented by Chemical formula 2-4, and Compound 2-5 represented by Chemical formula 2-5, about 5 to about 15% of Compound 3 including at least one of Compound 3-1 represented by Chemical formula 3-1 and Compound 3-2 represented by Chemical formula 3-2, about 5 to about 10% of Compound 4 represented by Chemical formula 4, and
about 10 to about 30% of Compound 5 including at least one of Compound 5-1 represented by Chemical formula 5-1, Compound 5-2 represented by Chemical formula 5-2, and Compound 5-3 represented by Chemical formula 5-3: 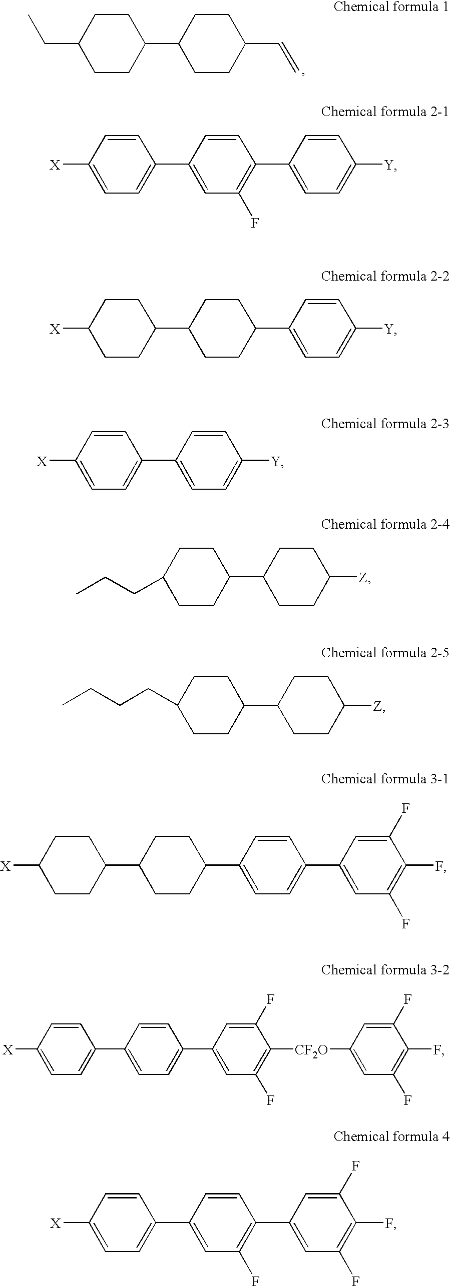 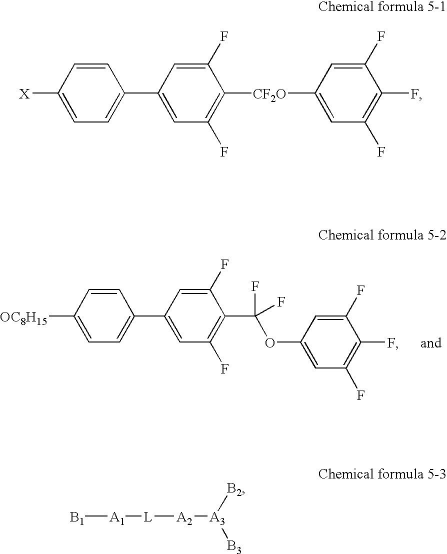
in the formulas, X independently representing a C2 to C7 alkyl or alkoxy group, Y independently representing a C2 to C7 alkyl or alkenyl group, Z representing a C2 to C7 alkenyl group, A₁, A₂, and A₃ each independently representing one of 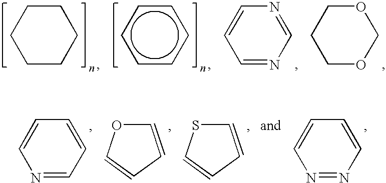
n independently representing one of 1 to 10, B₁ representing one of a C1 to C10 alkyl, alkoxy, alkenyl, and alkenyloxy group, B₂ representing one of F, Cl, and CN, B₃ representing one of a C1 to C10 alkyl group, a C1 to C10 alkoxy group, CN, and halogen, and L representing a tolane group, an ester group, a C1 to C10 alkoxy group, and a C1 to C10 alkyl group or does not exist.

8. The liquid crystal display device according to claim 7, wherein the compound 5 comprises the compound 5-2 and compound 5-3.

9. The liquid crystal display device according to claim 7, wherein a dielectric anisotropy of the liquid crystal composition is about 6.0 to about 9.0 at 20° C.

10. The liquid crystal display device according to claim 7, wherein a refractive anisotropy of the liquid crystal composition is about 0.12 to about 0.14 at 20° C.

11. The liquid crystal display device according to claim 7, wherein a rotational viscosity of the liquid crystal composition is about 55 mPa·s to about 65 mPa·s at 20C.

12. The liquid crystal display device according to claim 7, wherein a pitch of the liquid crystal composition is about 45 μm to about 55 μm.

13. The liquid crystal display device according to claim 12, wherein a cell gap of the liquid crystal display device is about 2.5 μm to about 3.5 μm

14. The liquid crystal display device according to claim 13, wherein a driving voltage (AVDD) of the liquid crystal display device is about 8.0V to about 9.0V.

15. The liquid crystal display device according to claim 14, wherein a response time of the liquid crystal layer is about 4.5 ms to about 6 ms.

16. The liquid crystal display device according to claim 14, wherein a contrast ratio of the liquid crystal display device is about 700:1 to about 1200:1.

17. The liquid crystal display device according to claim 7, wherein a delay value of the liquid crystal layer is about 380 nm to about 440 nm.
